(19) United States
(12) Patent Application Publication
(10) Pub. No.: US 2010/0120478 A1
(43) Pub. Date: May 13, 2010

(54) ELECTRONIC APPARATUS

(75) Inventors: Yoshihiro NOMURA, Tokyo (JP); Katsuhiko Ikeda, Tokyo (JP); Toshihisa Yamamoto, Tokyo (JP); Tomonori Sunazuka, Tokyo (JP); Kenji Akiyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/436,896

(22) Filed: May 7, 2009

(30) Foreign Application Priority Data
Nov. 10, 2008 (JP) P2008-287891

(51) Int. Cl. H04M 1/00

(52) U.S. Cl. 455/575.4

(57) ABSTRACT

An electronic apparatus includes: at least two casings changeable in positional relationship between the at least two casings from a first state to a second state that is different from the first state; an input module configured to input a command by touch, a first detector configured to detect a start of a transition from the first state to the second state; a second detector configured to detect a completion of the transition; and an input controller configured to disable input through the input module in a time between the start detected by the first detector and the completion detected by the second detector.

### CROSS-REFERENCE TO RELATED APPLICATIONS

The entire disclosure of Japanese Patent Application No. 2008-287891 filed on Nov. 10, 2008, including specification, claims, drawings and abstract is incorporated herein by reference in its entirety.

### BACKGROUND

1. Field of the Invention

One aspect of the invention relates to an electronic apparatus having at least two casings changeable in positional relationship between the at least two casings from a first state to a second state that is different from the first state.

2. Description of the Related Art

Recently, with the increase in functionality of electronic apparatuses such as cell phones, electronic apparatus that are shaped so as to be superior in functionality and portability, such as slide-type, clamshell-type, and swivel-type ones, have come to be developed. However, such electronic apparatuses have a problem that the user is required to perform complicated operations to activate a desired function.

In view of the above, a cell phone is developed which has camera and mail functions and which is reduced in a degree of complexity of operations and shortened in a waiting time to activation of a desired function (see JP-A-2007-215218, for instance). This cell phone is equipped with a sensor for detecting an opening or closing action. If it is detected that an opening or closings action has been made with a particular key pressed, a certain function such as a camera function or a mail function is activated. The operations that the user is required to perform are thus simplified.

In a slide-type electronic apparatus (e.g., cell phone) in which plural casings are connected to each other in a slidable manner and electrostatic touchpads are provided on the top outside surface, one of the fingers, for example, holding the cell phone may touch an electrostatic touchpad inadvertently in opening or closing the cell phone by sliding its casings with respect to each other. In this case although the user intends to merely open or close the cell phones the cell phone performs an operation corresponding to the input through the electrostatic touchpad touched. This operation is not intended by the user.

Furthermore, if an incoming call occurs in such a cell phone being placed in a bag, a finger of the user or something in the bag may touch an electrostatic touchpad when the user takes the cell phone out of the bag. In this case, the cell phone performs an operation corresponding to the input through the electrostatic touchpad touched in spite of the user's intention of responding to or refusing to respond to the incoming call.

### SUMMARY

According to an aspect of the invention, there is provided an electronic apparatus including: at least two casings changeable in positional relationship between the at least two casings from a first state to a second state that is different from tile first state; an input module configured to input a command by touch; a first detector configured to detect a start of a transition from the first state to the second state; a second detector configured to detect a completion of the transition: and an input controller configured to disable input through the input module in a time between the start detected by the first detector and the completion detected by the second detector

### BRIEF DESCRIPTION OF THE DRAWINGS

Embodiment may be described in detail with reference to the accompanying drawings, in which:

FIG. 1A is an exemplary perspective view of an electronic apparatus (cell phone) according to the invention in a closed state;

FIG. 1B is an exemplary perspective view of the electronic apparatus (cell phone) according to the invention in an open state;

FIG. 2 is an exemplary functional block diagram of the electronic apparatus (cell phone) according to the invention;

FIG. 3 is exemplary schematic diagrams showing a method for detecting change of the electronic apparatus (cell phone) according to the invention from a closed state to an open state using plural Hall ICs incorporated in top casing and a magnet incorporated in a bottom casing;

FIG. 4 is exemplary schematic diagrams showing a method for detecting change of the electronic apparatus (cell phone) according to the invention from an open state to a closed state using the plural Hall ICs incorporated in the top casing and the magnet incorporated in the bottom casing;

FIG. 5 is exemplary schematic diagrams showing a method for detecting change of the electronic apparatus (cell phone) according to the invention from a closed state to an open state using a Hall IC incorporated in the bottom casing and plural magnets incorporated in the top casing;

FIG. 6 is exemplary schematic diagrams showing a method for detecting change of the electronic apparatus (cell phone) according to the invention from an open state to a closed state using the Hall IC incorporated in the bottom casing and the plural magnets incorporated in the top casing;

FIG. 7 is exemplary schematic views showing a state immediately before and after the user changes a shape of the electronic apparatus (cell phone) according to the invention from an open state to a closed state;

FIG. 8 is an exemplary flowchart showing an electrostatic touchpad control process which is executed by an electronic apparatus (cell phone) according to a first embodiment;

FIG. 9 is an exemplary timing chart illustrating the electrostatic touchpad control process shown in FIG. 8;

FIG. 10 is an exemplary flowchart showing another electrostatic touchpad control process which is executed by the electronic apparatus (cell phone) according to the first embodiment;

FIGS. 11A and 11B are exemplary timing charts illustrating the electrostatic touchpad control process shown in FIG. 10;

FIG. 12 is an exemplary flowchart showing an electrostatic touchpad control process which is executed by an electronic apparatus (cell phone) according to a second embodiment;

FIG. 13 is an exemplary timing chart illustrating the electrostatic touchpad control process shown in FIG. 12;

FIG. 14 is an exemplary flowchart showing another electrostatic touchpad control process which is executed by the electronic apparatus (cell phone) according to the second embodiment;

FIGS. 15A and 15B are timing charts illustrating the electrostatic touchpad control process shown in FIG. 14;

FIG. 16 is a flowchart showing an electrostatic touchpad control process which is executed by an electronic apparatus (cell phone) according to a third embodiment; and

FIG. 17 shows example pictures that are displayed when the electronic apparatus (cell phone) according to the third embodiment executes the electrostatic touchpad control process shown in FIG. 16.

### DETAILED DESCRIPTION OF THE EMBODIMENTS

### First Embodiment

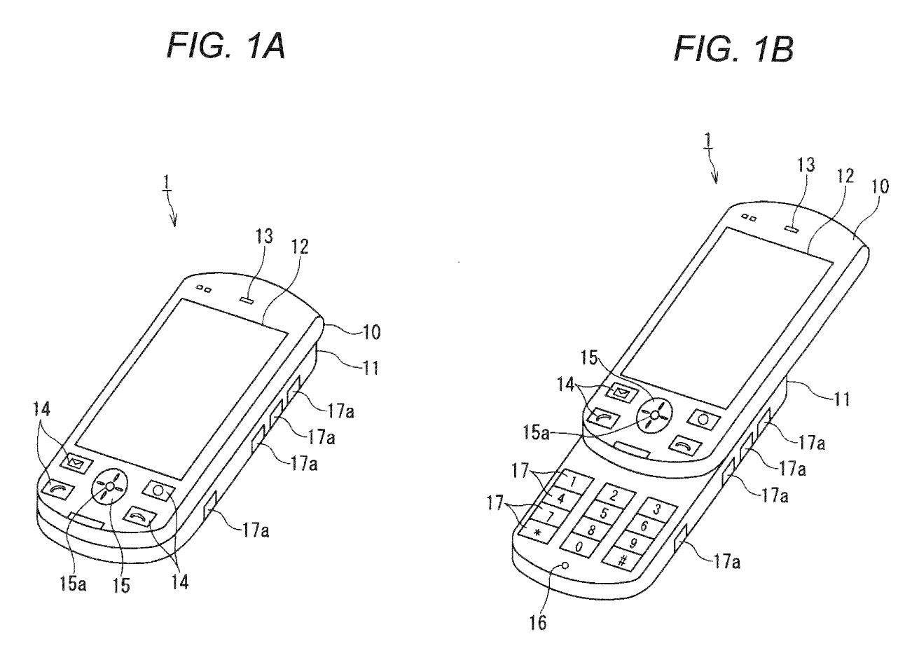

A first embodiment of the electronic apparatus according to the present invention will be hereinafter described with reference to FIGS. 1 to 11. An openable/closable cell phone 1 in which plural casings are connected to each other in a slidable manner will be described below as an example of the electronic apparatus according to the invention.

FIG. 1A is a perspective view of the cell phone 1 in a closed state, and FIG. 1B is a perspective view of the cell phone 1 in an open state. As shown in FIGS. 1A and 1B, the cell phone 1 is configured in such a manner that a rectangular-plate-shaped top casing 10 and a bottom casing 11 having substantially the same shape as the top casing 10 are placed on each other (their confronting surfaces are covered with each other) in a closed state. The top casing 10 and the bottom casing 11 are connected to each other so as to be slidable with respect to each other by a certain length in a certain direction (e.g., in the longitudinal direction). The cell phone 1 is changed from a closed state to an open state or vice versa by sliding the top casing 10 with respect to the bottom casing 11.

The outside surface (i.e., the surface that is not opposed to the bottom casing 11) of the top casing 10 is provided with a display 12 for displaying a picture of a text, an image, or the like and a speaker 13 for outputting sound. The outside surface of the top casing 10 is also provided with plural electrostatic touchpads 14 which are contact-sensing sensors and receive a command when touched by, for example, a finger of the user and a rotary key 15 which receives a command according to a rotation direction and angle when rotated by the user. An operation key 15a for receiving a command when pressed is disposed at the center of the rotary key 15.

Each electrostatic touchpad 14 is configured in such a manner that many minute electrodes are arranged under a pad, and is able to detect a position where a charge variation has occurred. If a conductor such as a finger of the user or a dedicated pen comes close to the electrodes with the pad (insulator) interposed in between, a capacitor is formed with the electrodes and the finger servings like pole plates. The capacitor configured of the electrodes and the finger can store a very small amount of charge, and the touch of the finger can be detected by detecting the charge on the electrodes side.

The display 12, the speaker 13, the electrostatic touchpads 14, and the rotary key 15 are provided so as to be exposed to the outside irrespective of whether the cell phone 1 is closed or opened. Therefore, irrespective of whether the cell phone 1 is closed or opened, the user can view the screen of the display 12 or inputs a command through the electrostatic touchpads 14 or the rotary key 15.

The inside surface (i.e., the surface to be opposed to the top casing 10) of the bottom casing 11 is provided with a microphone 16 for picking tip voice and plural operation keys 17 for receiving a command when pressed by the user. Whereas the microphone 16 and the operation keys 17 are covered with the top casing 10 and hence are not exposed to the outside in a state that the cell phone 1 is closed, they are exposed to the outside in a state that the cell phone 1 is opened by sliding the top casing 10 with respect to the bottom casing 11. Therefore, whereas the user can input a command through the operation keys 17 in a state that the cell phone 1 is opened, the user cannot do so in a state that the cell phone 1 is closed. The user inputs a command through the operation keys 17 in a state after changing the cell phone 1 into an open state.

One side surface of the bottom casing 11 is provided with plural side keys 17a for receiving a command when pressed by the user. The side keys 17a are provided so as to be exposed to the outside irrespective of whether the cell phone 1 is closed or opened. Therefore irrespective of whether the cell phone 1 is closed or opened, the user can input a command through the side keys 17a.

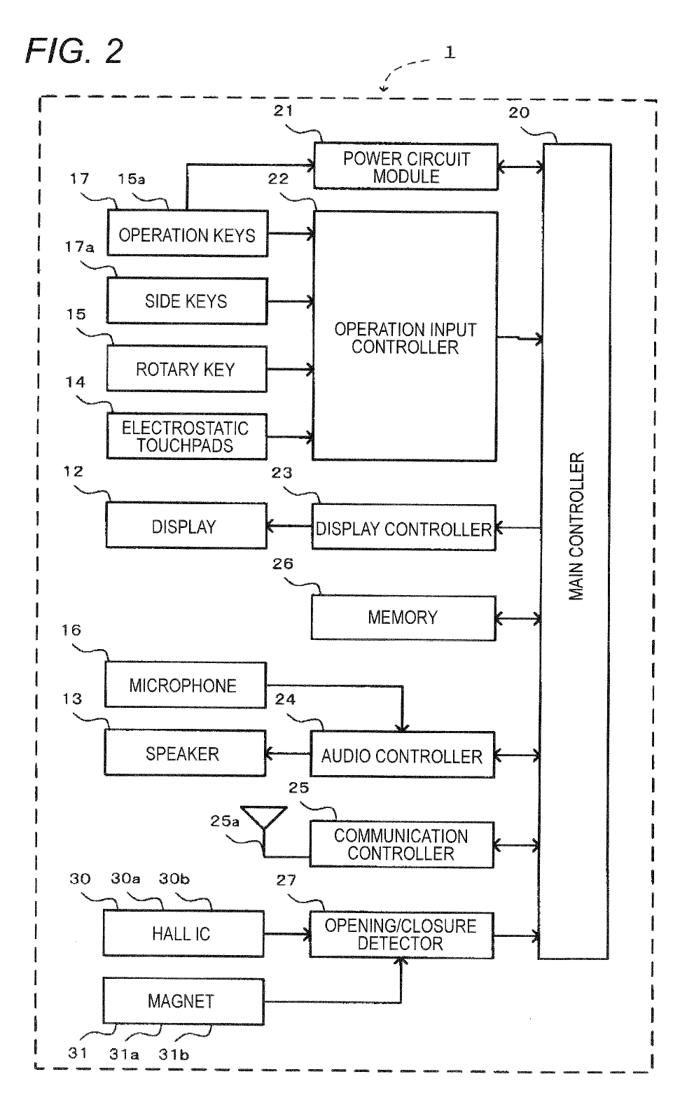

Next, functions of the cell phone 1 will be described with reference to a block diagram of FIG. 2. As shown in FIG. 2, the cell phone 1 is configured in such a manner that a main controller 20, a power circuit module 21, an operation input controller 22, a display controller 23, an audio controller 24, a communication controller 25, a memory 26, and an opening/closure detector 27 are connected to each other via a bus so as to communicate with each other.

Equipped with a central processing unit (CPU), the main controller 20 performs overall control on the cell phone 1 and executes an electrostatic touchpad control process (described later) and performs other various kinds of processing such as computation processing and control processing. Equipped with a power source such as a battery, the power circuit module 21 switches between power on and off states in response to an input made by the user through one of the operation keys 17 and supplies power to the individual sections from the power source in a power-on state to render the cell phone 1 operational.

The operation input controller 22 is equipped with input interfaces for the electrostatic touchpads 14, the rotary key 15, the operation keys 17, and the side keys 17a. When detecting an operation such as rotation of the rotary key 15 or pressing of an operation key 17 or a side key 17a, the operation input controller 22 generates a signal indicating the operation and sends it to the main controller 20. When detecting a touch to an electrostatic touchpad 14, the operation input controller 22 generates a touch detection signal indicating the occurrence of the touch and sends it to the main controller 20. Furthermore, when detecting cancellation of a touch to an electrostatic touch pad 14 after detection of the touch, the operation input controller 22 generates a touch cancellation detection signal indicating the touch cancellation of the electrostatic touch pad 14 and sends it to the main controller 20.

Having a display interface for the display 12, the display controller 23 displays a picture of a text an image, or the like on the display 12 under the control of the main controller 20.

The audio controller 24 generates an analog audio signal from a voice picked up by the microphone 16 and converts the analog audio signal into a digital audio signal under the control of the main controller 20. When acquiring a digital audio signal, the audio controller 24 converts the digital audio signal into an analog signal and outputs it through the speaker 13 as a voice or a sound tinder the control of the main controller 20.

The communication controller 25 performs inverse spectrum spreading on a reception signal received from a base station (not shown) via an antenna 25a and thereby restores data under the control of the main controller 20. According to a command from the main controller 20, the data is sent to the audio controller 24 and output from the speaker 13, sent to the display controller 23 and displayed on the display 12, or stored in the memory 26. When acquiring audio data picked up by the microphone 16, data that is input through the electrostatic touchpads 14, the rotary key 15, the operation keys 17, or the like, or data stored in the memory 26, the communication controller 25 performs spectrum spreading on the data and transmits resulting data to a base station via the antenna 25a under the control of the main controller 20.

The memory 26 consists of a ROM (read-only memory) for storing processing programs for processing to be performed by the main controller 20, data necessary for such processing, and other information, a hard disk drive, a non-volatile memory, a database, a RAM (random access memory) for temporarily storing data that is used when the main controller 20 performs processing, etc. It is assumed that a processing program according to which the main controller 20 executes the electrostatic touchpad control process (described later) is stored in the ROM, for example.

Equipped with plural Hall ICs 30a and 30b and a single magnet 31, the opening/closure detector 27 detects whether the cell phone 1 is in an open state or a closed state by detecting magnetism of the magnet 31 with the Hall ICs 30a and 30b. The Hall IC is a single-package device consisting of a Hall device which is a magnetic sensor and an IC for converting an output signal of the Hall device into a digital signal. The Hall IC has four terminals, that is, a power terminal, a GND terminal, an S-pole detection output terminal, and an N-pole detection output terminal.

When the cell phone 1 starts to be changed from a closed state to an open state, the opening/closure detector 27 generates an opening start detection signal and sends it to the main controller 20. When the cell phone 1 has been opened completely, the opening/closure detector 27 generates an opening completion detection signal and sends it to the main controller 20. When the cell phone 1 starts to be changed from an open state to a closed state, the opening/closure detector 27 generates a closing start detection signal and sends it to the main controller 20. When the cell phone 1 has been closed completely, the opening/closure detector 27 generates a closing completion detection signal and sends it to the main controller 20.

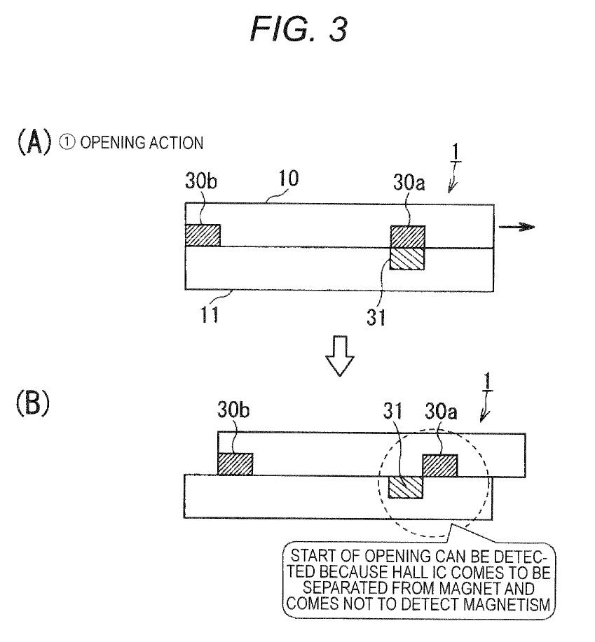

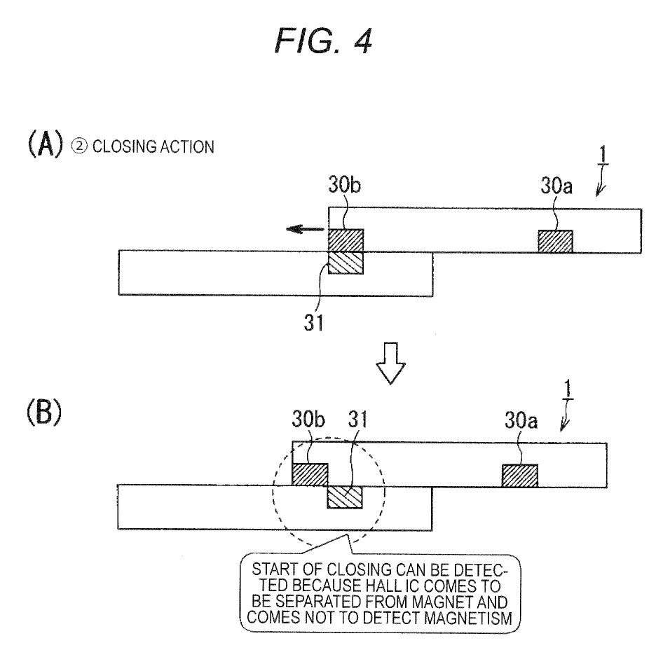

FIG. 3 shows schematic diagrams showing a method for detecting change of the cell phone 1 from a closed state to an open state using the plural Hall ICs 30a and 30b incorporated in the top casing 10 and the magnet 31 incorporated in the bottom casing 11. FIG. 4 are schematic diagrams showing a method for detecting change of the cell phone 1 from an open state to a closed state using the plural Hall ICs 30a and 30b incorporated in the top casing 10 and the magnet 31 incorporated in the bottom casing 11. As shown in FIGS. 3 and 4, the Hall ICs 30a and 30b are disposed in the top casing 10 at prescribed positions and the magnet 31 is disposed in the bottom casing 11 at a prescribed position.

The Hall ICs 30a and 30b and the magnet 31 are disposed at such positions that the Hall IC 30a is opposed to the magnet 31 when the cell phone 1 is in a closed state (see FIG. 3, section (A)) and the Hall IC 30b is opposed to the magnet 31 when the cell phone 1 is in an open state (see FIG. 3, section (B)). Each of the Hall ICs 30a and 30b detects magnetism of the S and N poles.

As shown in FIG. 3, section (A), the opening/closure detector 27 can determine that the cell phone 1 is in a closed state while the Hall IC 30a detects magnetism of the magnet 31. As shown in FIG. 3, section (B), the opening/closure detector 27 can determine that change of the cell phone 1 from a closed state to an open state has started if the Hall IC 30a comes not to detect magnetism of the magnet 31. The opening/closure detector 27 can determine that the cell phone 1 has been changed into a completely open state if the Hall IC 30b detects magnetism of the magnet 31.

As shown in FIG. 4, section (A), the opening/closure detector 27 can determine that the cell phone 1 is in an open state while the Hall IC 30b detects magnetism of the magnet 31. As shown in FIG. 4, section (B), the opening/closure detector 27 can determine that change of the cell phone 1 from an open state to a closed state has started if the Hall IC 30b comes not to detect magnetism of the magnet 31. The opening/closure detector 27 can determine that the cell phone 1 has been changed into a completely closed state if the Hall IC 30a detects magnetism of the magnet 31.

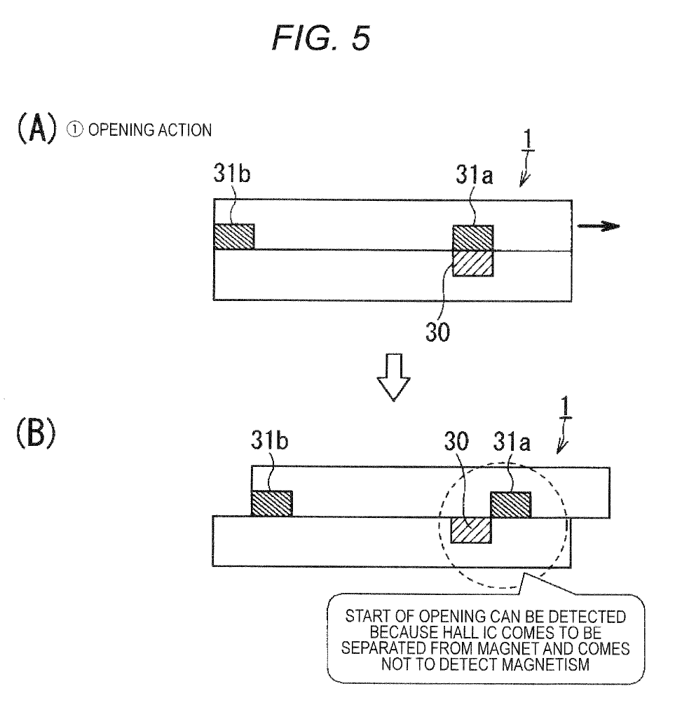

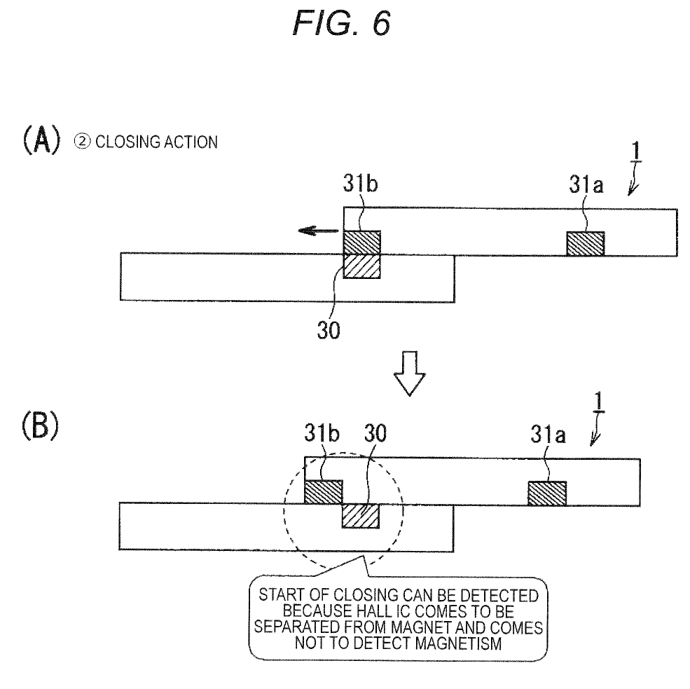

The opening/closure detector 27 may be equipped with a single Hall IC 30 and plural magnets 31a and 31b instead of the plural Hall ICs 30a and 30b and the single magnet 31. FIG. 5 shows schematic diagrams showing another method for detecting change of the cell phone 1 from a closed state to an open state using the Hall IC 30 incorporated in the bottom casing 11 and the plural magnets 31a and 31b incorporated in the top casing 10. FIG. 6 shows schematic diagrams showing another method for detecting change of the cell phone 1 from an open state to a closed state using the Hall IC 30 incorporated in the bottom casing 11 and the plural magnets 31a and 31b incorporated in the top casing 10.

As shown in FIGS. 5 and 6, the Hall IC 30 is disposed in the bottom casing 11 at a prescribed position and the magnets 31a and 31b are disposed in the top casing 10 at prescribed positions. The Hall IC 30 and the magnets 31a and 31b are disposed at such positions that the Hall IC 30 is opposed to the magnet 31a when the cell phone 1 is in a closed state (see FIG. 5, section (A)) and the Hall IC 30 is opposed to the magnet 31b when the cell phone 1 is in an open state (see FIG. 5, section (B)). The Hall IC 30 detects magnetism of the S and N poles.

As shown in FIG. 5, section (A), the opening/closure detector 27 can determine that the cell phone 1 is in a closed state while the Hall IC 30 detects magnetism of the magnet 31a. As shown in FIG. 5, section (B), the opening/closure detector 27 can determine that change of the cell phone 1 from a closed state to an open state has started if the Hall IC 30 comes not to detect magnetism of the magnet 31a. The opening closure detector 27 can determine that the cell phone 1 has been changed into a completely open state if the Hall IC 30 detects magnetism of the magnet 31b.

As shown in FIG. 6, section (A), the opening/closure detector 27 can determine that the cell phone 1 is in an open state while the Hall IC 30 detects magnetism of the magnet 31b. As shown in FIG. 6, section (B), the opening/closure detector 27 can determine that change of the cell phone 1 from an open state to a closed state has started if the Hall IC 30 comes not to detect magnetism of the magnet 31b. The opening/closure detector 27 can determine that the cell phone 1 has been changed into a completely closed state if the Hall IC 30 detects magnetism of the magnet 31a.

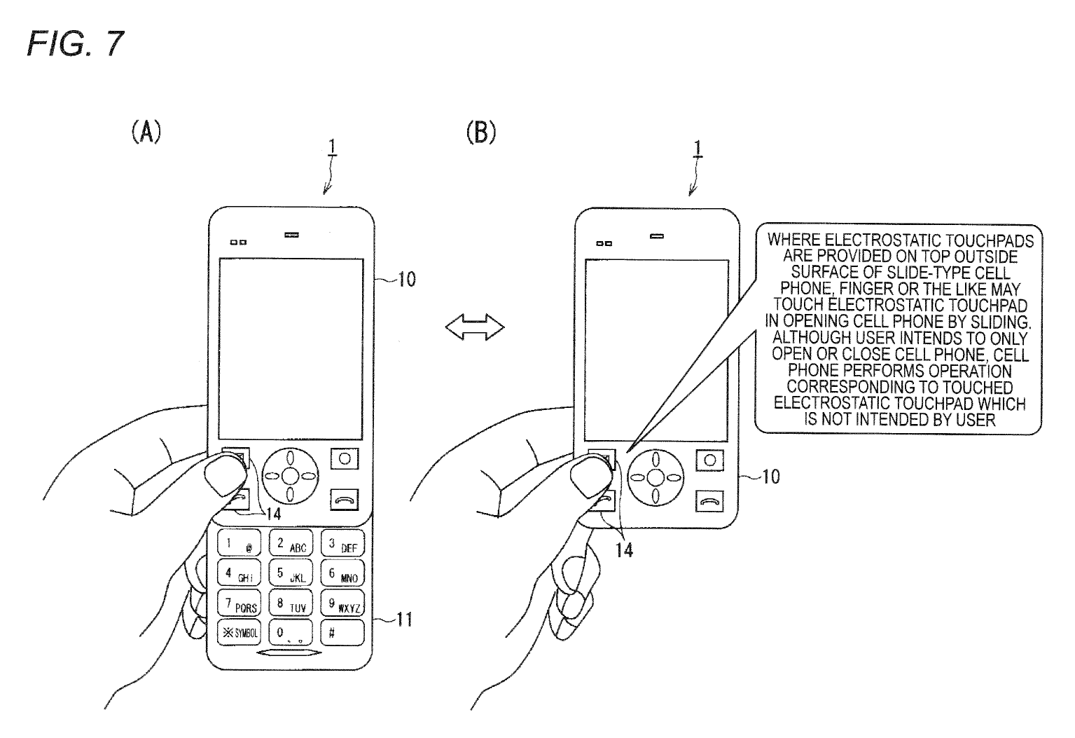

FIG. 7, section (A) is a schematic view showing a state immediately before the user changes the shape of the cell phone 1 from an open state to a closed state. FIG. 7, section (B) is a schematic view showing a state immediately after the user changes the cell phone 1 from an open state to a closed state. As shown in FIG. 7, if a finger of the user touches an electrostatic touchpad 14 inadvertently when the user has changed, from a closed state to an open state, the cell phone 1 which can be opened and closed and in which the electrostatic touch pads 14 are exposed to the outside in a closed state, the cell phone 1 may detect the touch to the electrostatic touchpad 14, determine that an input has been made, and perform an operation that is not intended by the user unless a proper measure is taken.

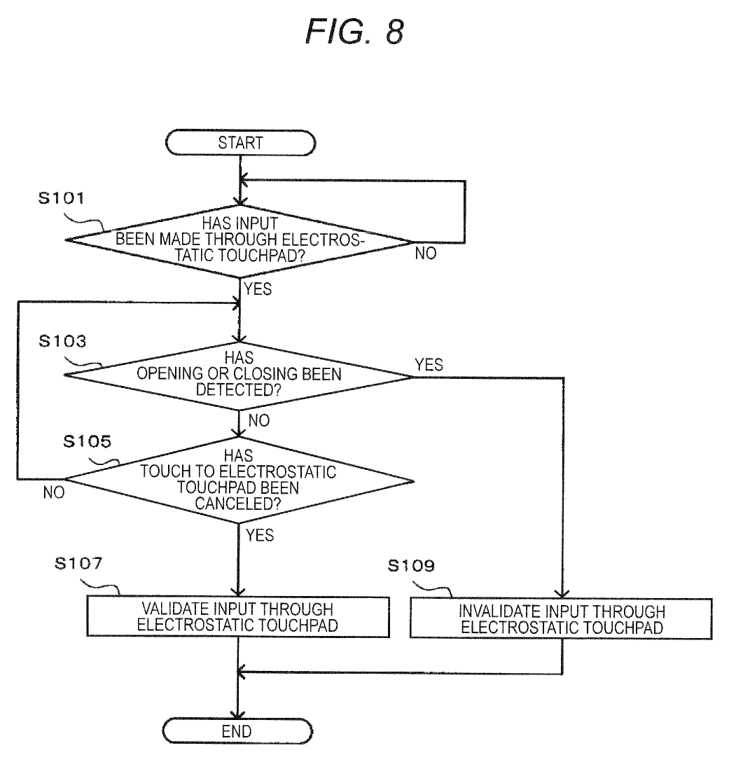

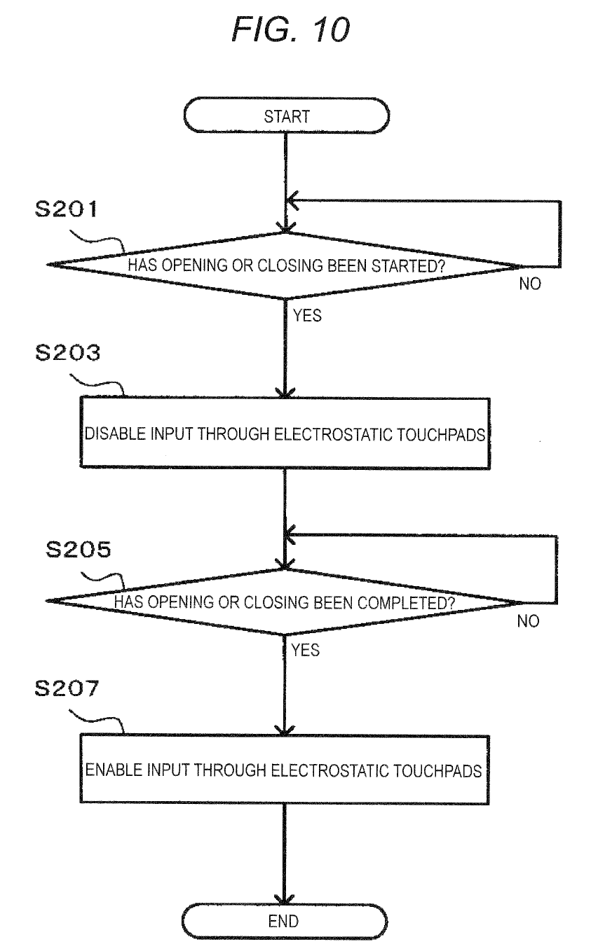

In view of the above when receiving an input through an electrostatic touchpad 14, the cell phone 1 determines whether the input is one intended by the user or not and executes an electrostatic touchpad control process which invalidates the input if the input is determined to be one that is not intended by the user. How the cell phone executes the electrostatic touchpad control process will be described below with reference to flowcharts of FIGS. 8 and 10. In the following, the word “step” may be omitted as exemplified by “S101” which is an abbreviation of “step S101.”

First, a process of a case that whether the cell phone 1 has been opened or closed is determined after a start of an input through an electrostatic touchpad 14 will be described with reference to the flowchart of FIG. 8. First, the main controller 20 determines whether an input has been made through an electrostatic touchpad 14 (S101). The main controller 20 determines that an input has been made through an electrostatic touchpad 14 if it receives an electrostatic touchpad touch detection signal from the operation input controller 22. If no input has been made through an electrostatic touchpad 14 (S101: no), the main controller 20 stands by until an input is made through the electrostatic touchpads 14.

If an input has been made through an electrostatic touchpad 14 (S101: yes), the main controller 20 determines whether opening or closing of the cell phone 1 has been detected (S103). The main controller 20 determines that opening or closing has been detected if it receives an opening start detection signal or a closing start detection signal from the opening/closure detector 27.

If opening or closing has not been detected yet (S103: no), the main controller 20 determines whether the touch to the electrostatic touchpad 14 has been canceled (S105). The main controller 20 determines that the touch to the electrostatic touchpad 14 has been canceled if it receives an electrostatic touchpad touch cancellation detection signal from the operation input controller 22. If the touch to the electrostatic touchpad 14 has not been canceled yet (S105: no), the process returns to step S103, where the main controller 20 again determines whether opening or closing of the cell phone 1 has been detected.

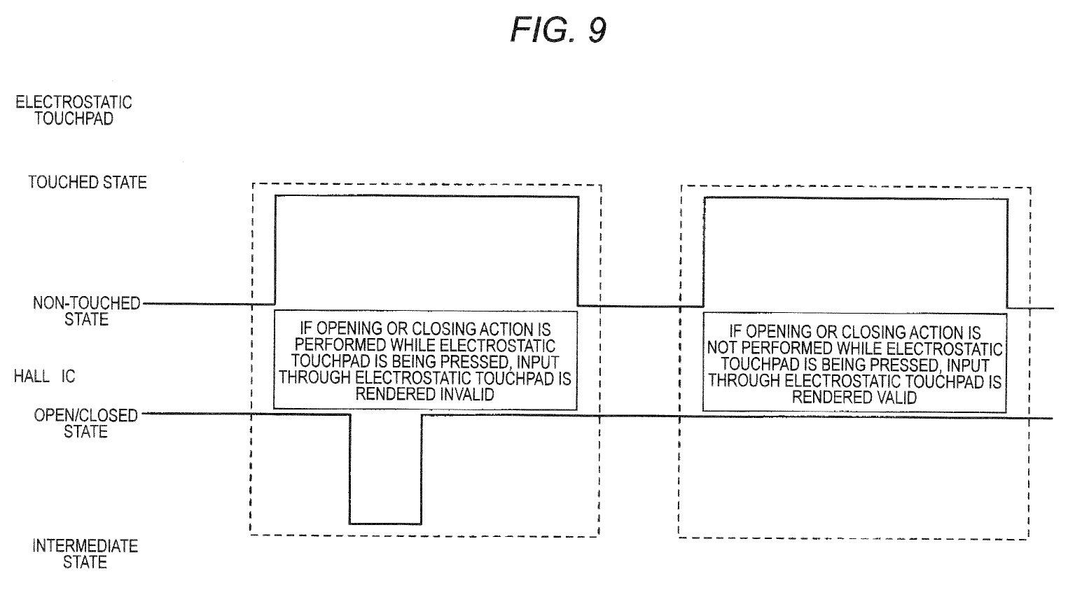

If touch cancellation of the electrostatic touchpad 14 is detected (S105: yes) which means that the input through the electrostatic touchpad 14 has been completed without opening or closing of the cell phone 1, at step S107 the main controller 20 determines that the input is one that is intended by the user and validates the input through the electrostatic touchpad 14 which was detected at step S101. For example, as shown in FIG. 9, if the cell phone 1 is not opened or closed while an input is being made through an electrostatic touchpad 14, the input is rendered valid.

If opening or closing has been detected (S103: yes) which means that the input through the electrostatic touchpad 14 was made while the cell phone 1 was being opened or closed, at step S109 the main controller 20 determines that the input is one that is not intended by the user and invalidates the input through the electrostatic touchpad 14 which was detected at step S101. For example, as shown in FIG. 9, if the cell phone 1 is opened or closed while am input is being made through an electrostatic touchpad 14, the input is rendered invalid.

As described above if detecting opening or closing of the cell phone 1 between detection of a touch to an electrostatic touchpad 14 to detection of its cancellation, the cell phone 1 determines that the input through the electrostatic touchpad 14 is an erroneous one and invalidates the input. If not detecting opening or closing of the cell phone 1 between detection of a touch to an electrostatic touchpad 14 to detection of its cancellation, the cell phone 1 determines that the input through the electrostatic touchpad 14 is a normal one and validates the input. As a result, even if the user touches an electrostatic touchpad 14 inadvertently in opening or closing the cell phone 1, the cell phone 1 is prevented from performing, in response to the input, an operation that is not intended by the user.

Next, a process of a case that an electrostatic touchpad control is performed according to opening/closing of the cell phone 1 will be described with reference to the flowchart of FIG. 10. First, the main controller 20 determines whether opening or closing of the cell phone 1 has been started (S201). The main controller 20 determines that opening or closing of the cell phone 1 has been started if it receives an opening start detection signal or a closing start detection signal from the opening/closure detector 27.

If opening or closing of the cell phone 1 has not been started yet (S201: no), the main controller 20 stands by until a start of opening or closing of the cell phone 1. If opening or closing of the cell phone 1 has been started (S201: yes), the main controller 20 disables input through the electrostatic touchpads 14 (S203).

The main controller 20 determines whether the opening or closing of the cell phone 1 has been completed (S205). The main controller 20 determines that the opening or closing of the cell phone 1 has been completed if it receives an opening completion detection signal or a closing completion detection signal from the opening/closure detector 27.

If the opening or closing of the cell phone 1 has not been completed yet (S205: no), the main controller 20 stands by with input through the electrostatic touchpads 14 kept disabled until completion of the opening or closing of the cell phone 1. If the opening or closing of the cell phone 1 has been completed (S205: yes), the main controller 20 enables input through the electrostatic touchpads 14 (S207).

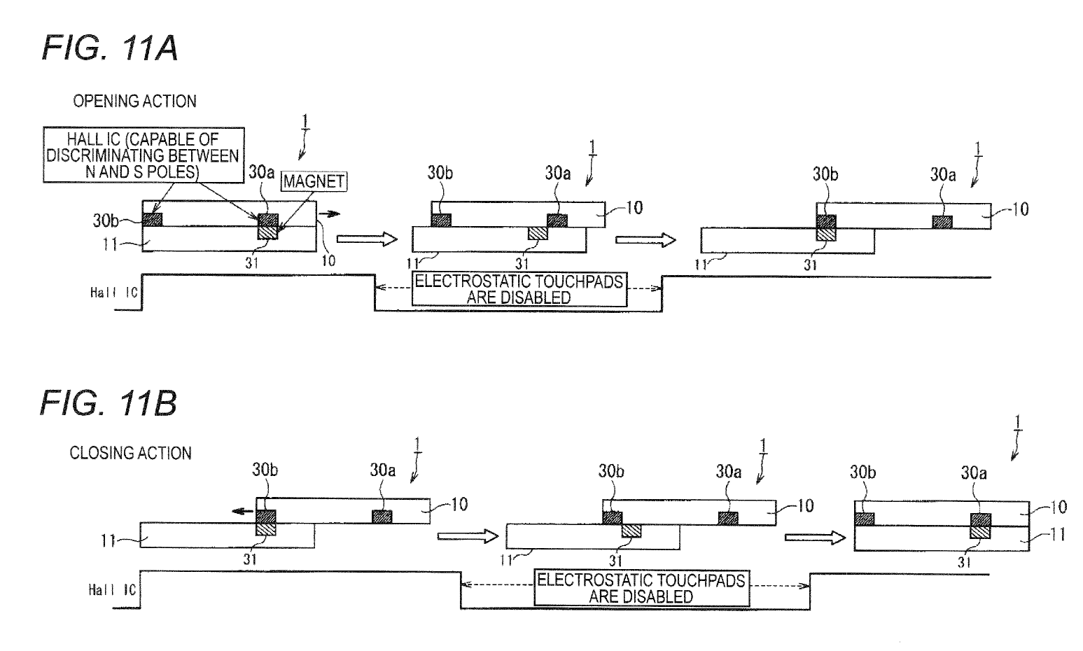

FIG. 11A shows an electrostatic touchpad input control when the cell phone 1 is changed from a closed state to an open state. As shown in FIG. 11A, input through the electrostatic touchpads 14 is enabled while the cell phone 1 is in a closed state. Input through the electrostatic touchpads 14 is disabled from a start of an action of opening the cell phone 1 to its completion. Input through the electrostatic touchpads 14 is enabled again when the cell phone 1 has been changed into an open state.

FIG. 11B shows an electrostatic touchpad input control when the cell phone 1 is changed from an open state to a closed state. As shown in FIG. 11B, input through the electrostatic touchpads 14 is enabled while the cell phone 1 is in an open state. Input through the electrostatic touchpads 14 is disabled from a start of an action of closing the cell phone 1 to its completion. Input through the electrostatic touchpads 14 is enabled again when the cell phone 1 has been changed into a closed state. In FIGS. 11A and 11B, diagrams of the Hall IC are irrespective of elapsed time, that is, they show that the Hall IC (30a, 30b) does not detect magnetism of the magnet 31 while the diagrams indicate a low level.

As described above, the cell phone 1 disables input through the electrostatic touchpads 14 from a start of opening or closing of the cell phone 1 to its completion. As a result, even if the user touches an electrostatic touchpad 14 inadvertently in opening or closing the cell phone 1, the cell phone 1 is prevented from performing, in response to the input, an operation that is not intended by the user.

According to the first embodiment, in the electronic apparatus (cell phone 1) in which the plural casings are connected to each other in an openable/closable manner and the electrostatic touchpads 14 are provided on the top outside surface, an erroneous input through an electrostatic touchpad 14 can be prevented when the user opens or closes the electronic apparatus.

### Second Embodiment

A second embodiment of the electronic apparatus according to the invention will be hereinafter described with reference to FIGS. 1 to 15. As in the first embodiment, an openable/closable cell phone 1 in which plural casings are connected to each other in a slidable manner will be described below as an electronic apparatus according to the second embodiment. Components, sections, etc. having the same ones in the first embodiment will be given the same reference symbols as the latter and will not be described redundantly.

The cell phone 1 according to the second embodiment has the same configuration as the configuration of the cell phone 1 according to the first embodiment (see FIGS. 1A and 1B). Furthermore, like the cell phone 1 according to the first embodiment, the cell phone 1 according to the second embodiment is configured in such a manner that a main controller 20, a power circuit module 21, an operation input controller 22, a display controller 23, an audio controller 24, a communication controller 25, a memory 26, and an opening/closure detector 27 are connected to each other via a bus so as to communicate with each other (see FIG. 2).

In the first embodiment, an input that is made through an electrostatic touchpad 14 both during change of the cell phone 1 from a closed state to an open state and during change from an open state to a closed state is rendered invalid. In contrast, in the second embodiment, whereas an input that is made through an electrostatic touchpad 14 during change of the cell phone 1 from an open state to a closed state is rendered invalid, an input that is made through an electrostatic touchpad 14 during change from a closed state to an open state is rendered valid.

The second embodiment is based on the following notion. It is not conceivable that the user makes a certain operation on the cell phone 1 in closing it. Should an input through an electrostatic touchpad 14 be accepted, corresponding processing may be performed though the cell phone 1 is closed. On the other hand, in opening the cell phone 1, the user should have an intention of making a certain operation on the cell phone 1: it is conceivable that the user manipulates an electrostatic touchpad 14 at the same time as opens the cell phone 1.

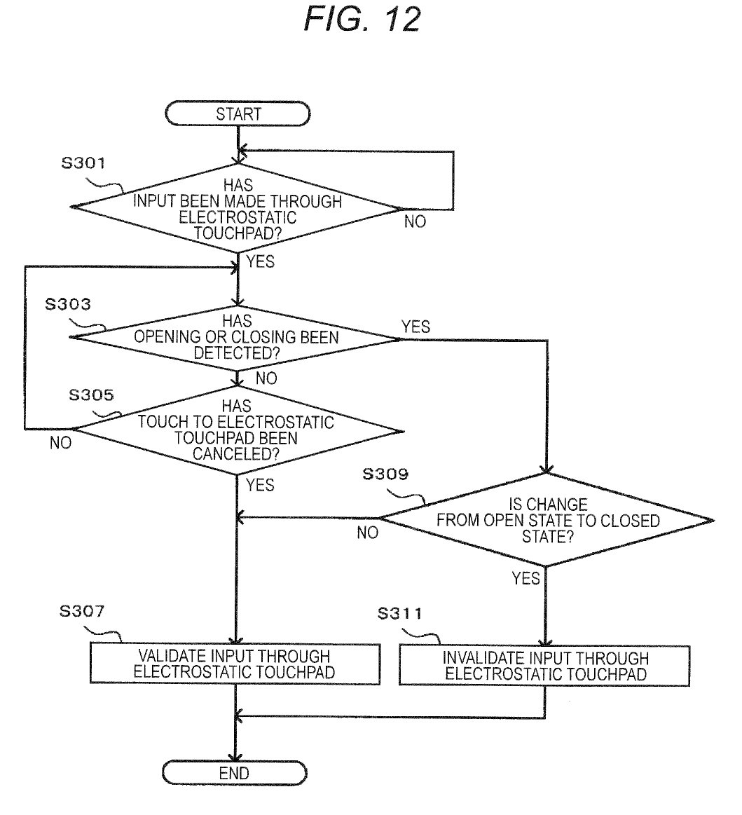

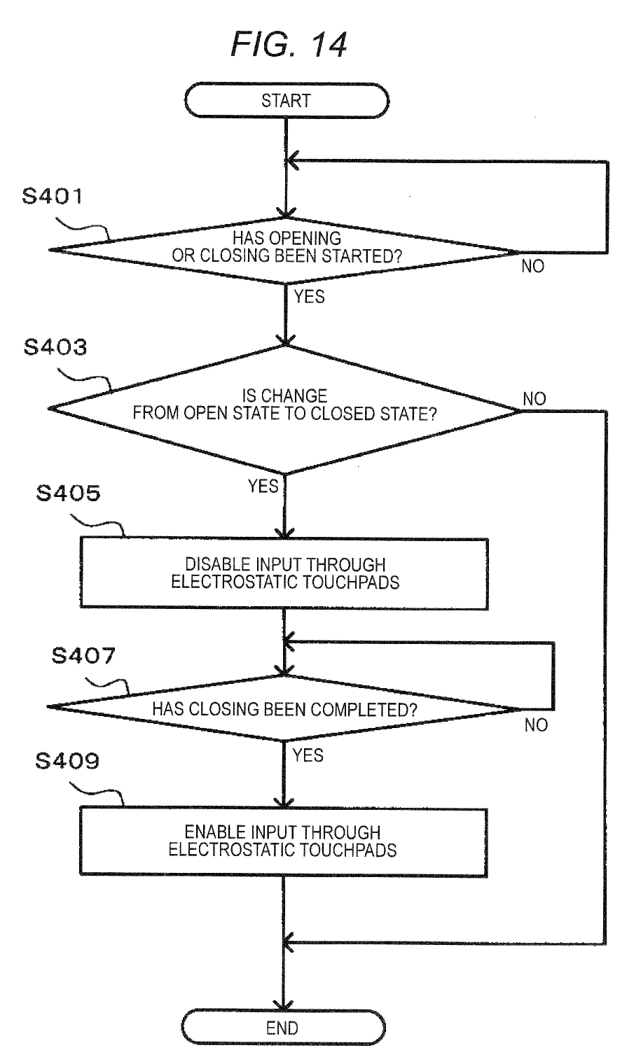

An electrostatic touchpad control process will be described with reference to flowcharts of FIGS. 12 and 14. In this electrostatic touchpad control process, when an input is made through an electrostatic touchpad 14, the cell phone 1 determines whether the input is one that is intended by the user or not. If the input is one that is not intended by the user, the input is rendered invalid.

First, a process of a case that whether the cell phone 1 has been opened or closed is determined after a start of an input through an electrostatic touchpad 14 will be described with reference to the flowchart of FIG. 12. First, the main controller 20 determines whether an input has been made through an electrostatic touchpad 14 (S301). The main controller 20 determines that an input has been made through an electrostatic touchpad 14 if it receives an electrostatic touchpad touch detection signal from the operation input controller 22. If no input has been made through an electrostatic touchpad 14 (S301: no), the main controller 20 stands by until an input is made through an electrostatic touchpad 14.

If an input has been made through an electrostatic touchpad 14 (S301: yes), the main controller 20 determines whether opening or closing of the cell phone 1 has been detected (S303). The main controller 20 determines that opening or closing has been detected if it receives an opening start detection signal or a closing start detection signal from the opening/closure detector 27.

If opening or closing has not been detected yet (S303: no), the main controller 20 determines whether the touch to the electrostatic touchpad 14 has been canceled (S305). The main controller 20 determines that the touch to the electrostatic touchpad 14 has been canceled if it receives an electrostatic touchpad touch cancellation detection signal from the operation input controller 22. If the touch to the electrostatic touchpad 14 has not been canceled yet (S305: no), the process returns to step S303, where the main controller 20 again determines whether opening or closing of the cell phone 1 has been detected.

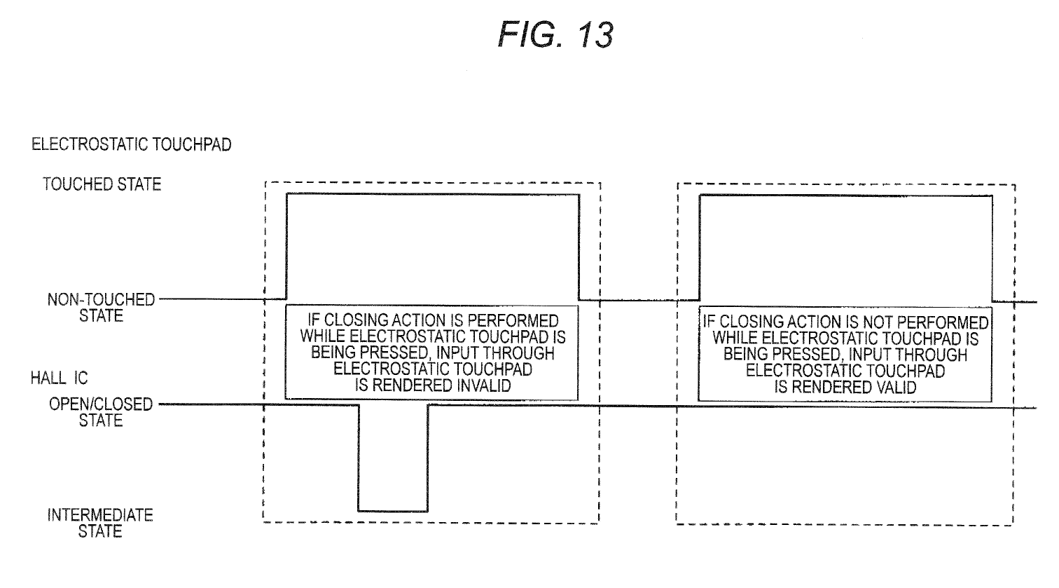

If touch cancellation of the electrostatic touchpad 14 is detected (S305: yes) which means that the input through the electrostatic touchpad 14 has been completed without opening or closing of the cell phone 1, at step S307 the main controller 20 determines that the input is one that is intended by the user and validates the input through the electrostatic touchpad 14 which was detected at step S301. For example, as shown in FIG. 13, if the cell phone 1 is not changed from an open state to a closed state while an input is being made through an electrostatic touchpad 14, the input is rendered valid.

If opening or closing has been detected (S303: yes), the main controller 20 determines whether the change is from an open state to a closed state (S309). The main controller 20 determines that the change is from an open state to a closed state if it received a closing start detection signal from the opening/closure detector 27 at step S303.

If the cell phone 1 has been changed from a closed state to an open state (S309: no) which means that the input through the electrostatic touchpad 14 was made while the cell phone 1 was being opened, at step S307 the main controller 20 determines that the input is one that is intended by the user and validates the input through the electrostatic touchpad 14 which was detected at step S301. For example, as shown in FIG. 13, if the cell phone 1 is not changed from an open state to a closed state while an input is being made through an electrostatic touchpad 14, the input is rendered valid.

If the cell phone 1 has been changed from an open state to a closed state (S309: yes) which means that the input through the electrostatic touchpad 14 was made while the cell phone 1 was being closed, at step S311 the main controller 20 determines that the input is one that is not intended by the user and invalidates the input through the electrostatic touchpad 14 which was detected at step S301. For example, as shown in FIG. 13, if the cell phone 1 is changed from an open state to a closed state while an input is being made through an electrostatic touchpad 14, the input is rendered invalid.

As described above if detecting closing of the cell phone 1 between detection of a touch to an electrostatic touchpad 14 to detection of its cancellation, the cell phone 1 determines that the input through the electrostatic touchpad 14 is an erroneous one and invalidates the input. If detecting opening of the cell phone 1 or not detecting opening or closing of the cell phone 1 between detection of a touch to an electrostatic touchpad 14 to detection of its cancellation, the cell phone 1 determines that the input through the electrostatic touchpad 14 is a normal one and validates the input. As a result, even if the user touches an electrostatic touchpad 14 inadvertently in closing the cell phone 1, the cell phone 1 is prevented from performing, in response to the input, an operation that is not intended by the user.

Next a process of a case that an electrostatic touchpad control is performed according to opening/closing of the cell phone 1 will be described with reference to the flowchart of FIG. 14. First, the main controller 20 determines whether opening or closing of the cell phone 1 has been started (S401). The main controller 20 determines that opening or closing of the cell phone 1 has been started if it receives an opening start detection signal or a closing start detection signal from the opening/closure detector 27.

If opening or closing of the cell phone 1 has not been started yet (S401: no), the main controller 20 stands by until a start of opening or closing of the cell phone 1. If opening or closing of the cell phone 1 has been started (S401: yes), the main controller 20 determines whether the change is from an open state to a closed state (S403). The main controller 20 determines that the change is from an open state to a closed state if it received a closing start detection signal form the opening/closure detection section 27 at step S401.

It the change is from a closed state to an open state (S403: no), the main controller 20 finishes the electrostatic touchpad control process with input through the electrostatic touchpads 14 kept enabled.

If the change is from an open state to a closed state (S403: yes), the main controller 20 disables input through the electrostatic touchpads 14 (S405). Then, the main controller 20 determines whether the cell phone 1 has been changed into a completely closed state (S407). The main controller 20 determines that the cell phone 1 has been changed into a completely closed state if it receives a closing completion detection signal from the opening/closure detector 27.

If that the cell phone 1 has not been changed into a completely closed state yet (S407: no), the main controller 20 stands by with input through the electrostatic touchpads 14 kept disabled until the cell phone 1 is changed into a completely closed state. If the cell phone 1 has been changed into a completely closed state (S407: yes), the main controller 20 enables input through the electrostatic touchpads 14 (S409).

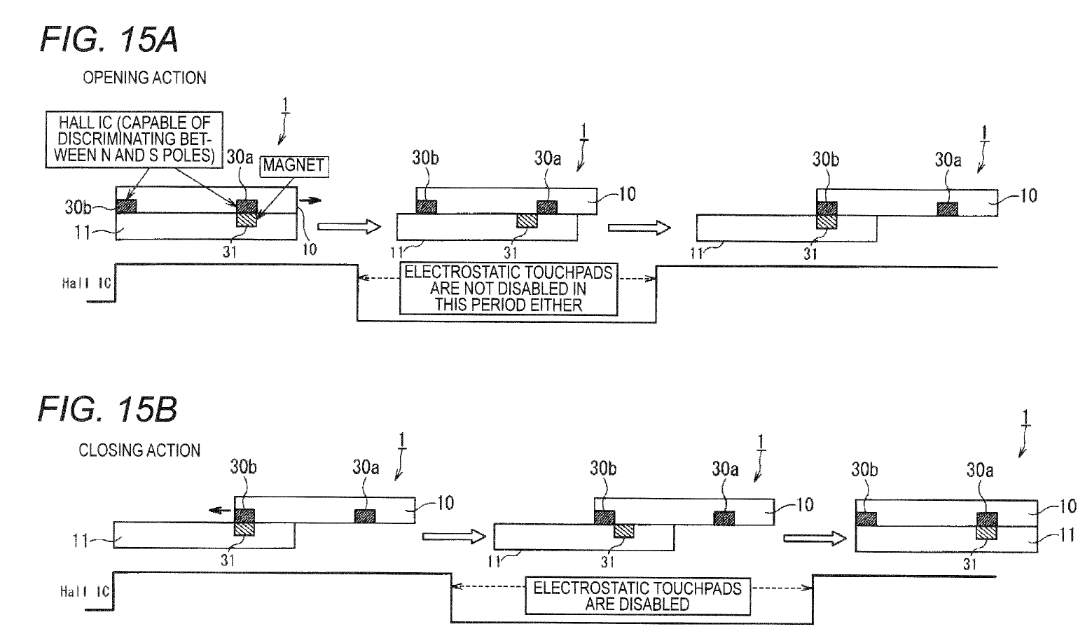

FIG. 15A shows an electrostatic touchpad input control when the cell phone 1 is changed from a closed state to an open state. As shown in FIG. 15A, input through the electrostatic touchpads 14 is kept enabled while the cell phone 1 is in a closed state, from a start of an action of opening the cell phone 1 to its completion, and after the completion of the change into an open state.

FIG. 15B shows an electrostatic touchpad input control when the cell phone 1 is changed from an open state to a closed state. As shown in FIG. 15B, input through the electrostatic touchpads 14 is enabled while the cell phone 1 is in an open state. Input through the electrostatic touchpads 14 is disabled from a start of an action of closing the cell phone 1 to its completion. Input through the electrostatic touchpads 14 is enabled again when the cell phone 1 has been changed into a closed state. In FIGS. 15A and 15B, diagrams of the Hall IC are irrespective of elapsed time, that is, they show that the Hall IC (30a, 30b) does not detect magnetism of the magnet 31 while the diagrams indicate a low level.

As described above, the cell phone 1 disables input through the electrostatic touchpads 14 from a start of closing of the cell phone 1 to its completion. As a result, even if the user touches an electrostatic touchpad 14 inadvertently in closing the cell phone 1, the cell phone 1 is prevented from performing, in response to the input, an operation that is not intended by the user.

According to the second embodiment, in the electronic apparatus (cell phone 1) in which the plural casings are connected to each other in an openable/closable manner and the electrostatic touchpads 14 are provided on the top outside surface, an erroneous input through an electrostatic touchpad 14 can be prevented when the user closes the electronic apparatus.

### Third Embodiment

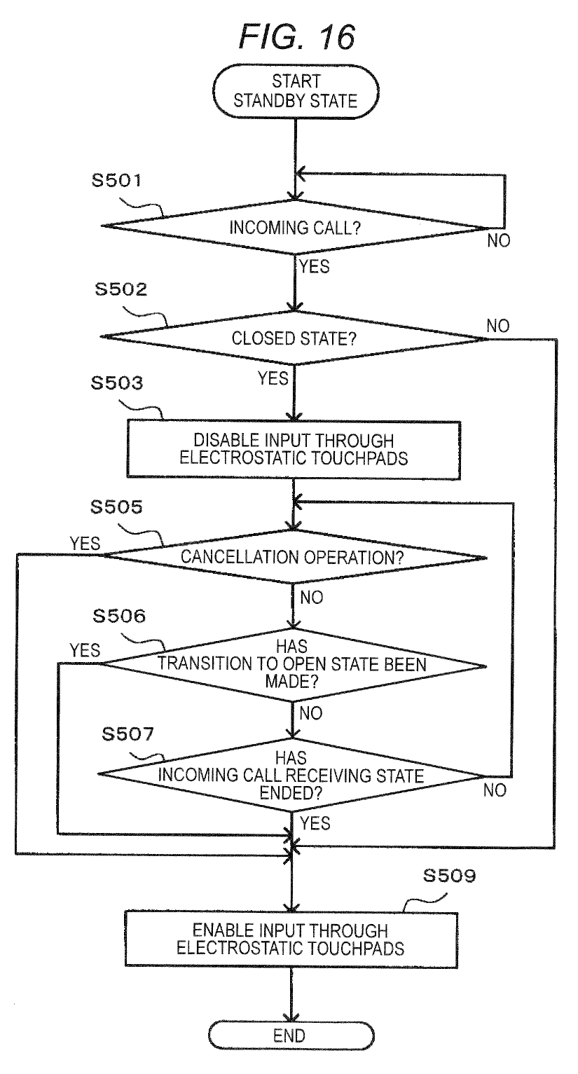

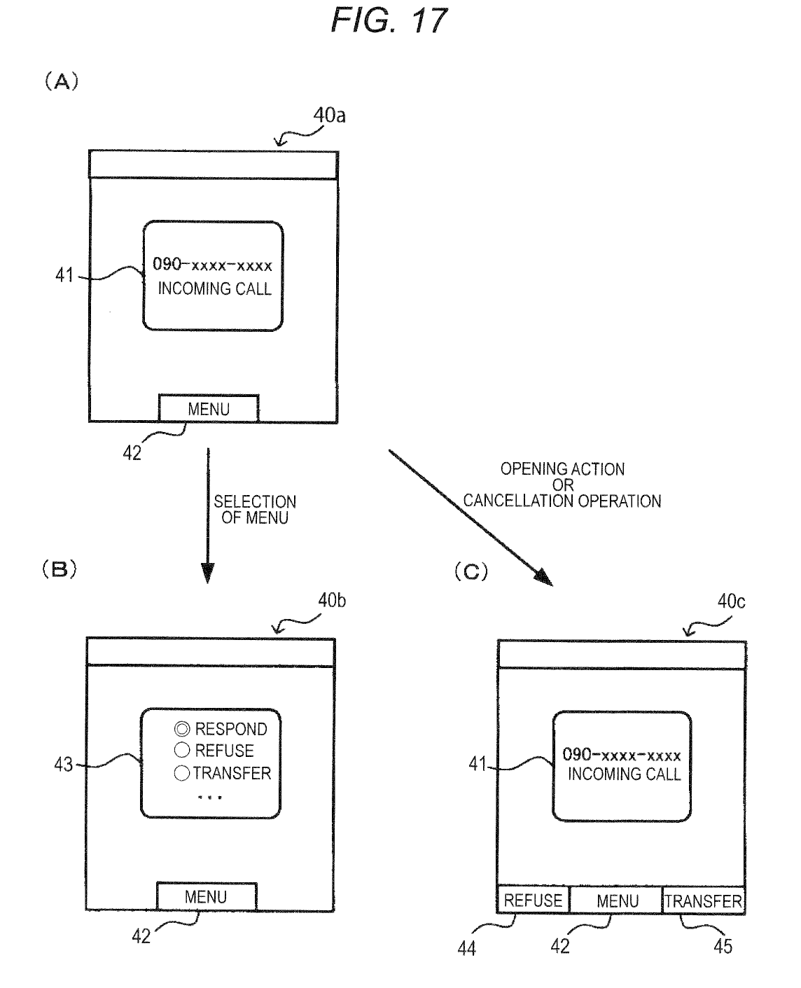

A third embodiment of the electronic apparatus according to the invention will be hereinafter described with reference to FIGS. 16 and 17. As in the first and second embodiments, an openable/closable cell phone 1 in which plural casings are connected to each other in a slidable manner will be described below as an electronic apparatus according to the third embodiment. Components, sections, etc. having the same ones in the first or second embodiment will be given the same reference symbols as the latter and will not be described redundantly.

The cell phone 1 according to the third embodiment has the same configuration as the configuration of the cell phones 1 according to the first and second embodiments (see FIGS. 1A and 1B). Furthermore, like the cell phones 1 according to the first and second embodiments, the cell phone 1 according to the third embodiment is configured in such a manner that a main controller 20, a power circuit module 21, an operation input controller 22, a display controller 23, an audio controller 24, a communication controller 25, a memory 26, and an opening/closure detector 27 are connected to each other via a bus so as to communicate with each other (see FIG. 2).

In the first and second embodiments, an input that is made through an electrostatic touchpad 14 both during change of the cell phone 1 from a closed state to an open state and during change from an open state to a closed state or only during change from an open state to a closed state is rendered invalid. In contrast, in the third embodiment, an input that is made through an electrostatic touchpad 14 is rendered invalid when an incoming call has occurred in the cell phone 1.

For example, if an incoming call occurs in the cell phone 1 being placed in a bag of the user, there may occur an event that something touches an electrostatic touchpad 14 when the user takes the cell phone 1 out of the bag and the cell phone 1 accepts an input through the electrostatic touchpad 14. In this case, the cell phone 1 may start a call, refuse to respond to it, or transfer it contrary to the intention of the user.

In view of the above, the cell phone 1 executes an electrostatic touchpad control process in which when an incoming call has occurred, input through the electrostatic touchpads 14 is disabled while the cell phone 1 is receiving the incoming call and input through the electrostatic touchpads 14 is enabled when the incoming call receiving state has ended because of a start of a call or disconnection of the incoming call. This electrostatic touchpad control process which is executed by the cell phone 1 will be described below with reference to a flowchart of FIG. 16 and pictures shown in FIG. 17.

First, the main controller 20 determines whether an incoming call has occurred in the cell phone 1 (S501). If no incoming call has occurred in the cell phone 1 (S501: no), the main controller 20 stands by until receiving an incoming call. If an incoming call has occurred in the cell phone 1 (S501: yes), the main controller 20 determines whether the cell phone 1 is in a closed state (S502). If the cell phone 1 is in an open state (S502: no), the main controller 20 enables input through the electrostatic touchpads 14 (S509).

If the cell phone 1 is in a closed state (S502: yes), the main controller 20 disables input through the electrostatic touchpads 14 (S503). FIG. 17, section (A) shows an example display picture 40a which is displayed on the display 12 when input through the electrostatic touchpads 14 is disabled in an incoming call receiving state. As shown in FIG. 17, section (A), an incoming call notification box 41 for notifying the user of occurrence of an incoming call by displaying incoming call information and a menu button 42 to be manipulated to display a menu are displayed in the display picture 40a. Since input through the electrostatic touchpads 14 is disabled, no buttons corresponding to electrostatic touchpads 14 are displayed. It is appropriate that a prescribed operation key 17 that is not an electrostatic touchpad 14 or the operation key 15a which is located at the center of the rotary key 15 be assigned to the menu button 42.

FIG. 17, section (B) shows an example display picture 40 which is displayed on the display 12 when the menu button 42 has been selected in an incoming call receiving state. If the user selects the menu button 42, as shown in FIG. 17, section (B) the main controller 20 displays a display picture 40b which includes an operation list presentation box 43. Operations to be made as a reaction to the incoming call, such as “respond,” “refuse,” and “transfer,” are presented in the operation list presentation box 43. The user selects an operation using the rotary key 15, the operation key 15a, a side key 17a, or the like.

The main controller 20 determines whether a cancellation operation has been made (S505). The main controller 20 determines that a cancellation operation has been made if a preset operation (e.g., opening or closing of the cell phone 1, pressing of a particular operation key 17, or pressing of a particular side key 17a) has been made.

If a cancellation operation has not been made yet (S505: no), the main controller 20 determines whether the cell phone 1 has been changed from the closed state to an open state (S506). If the cell phone 1 has been changed from the closed state to an open state (S506: yes), the main controller 20 enables input through the electrostatic touchpads 14 (S509).

If the cell phone 1 remains closed (S506: no), the main controller 20 determines whether the incoming call receiving state has ended (S507). The main controller 20 determines that the incoming call receiving state has ended if, for example, a call has started by responding to the incoming call according to a command from the user or the incoming call has been disconnected by its source. If the incoming call receiving state has not ended yet (S507: no), the process returns to step S505, where the main controller 20 again determines whether a cancellation operation has been made.

If a cancellation operation has been made (S505: yes) or the incoming call receiving state has ended (S507: yes), the main controller 20 enables input through the electrostatic touchpads 14 (S509). FIG. 17, section (C) shows an example display picture 40c which is displayed on the display 12 when a cancellation operation is made while the cell phone 1 is receiving an incoming call or the cell phone 1 makes a transition from a closed state to an open state while receiving an incoming call. As shown in FIG. 17, section (C), the main controller 20 displays a refuse button 44 for refusing to respond to the incoming call and a transfer button 45 for transferring the incoming call in addition to the incoming call notification box 41 and the menu button 42. The refuse button 44 and the transfer button 45 are buttons corresponding to electrostatic touchpads 14, and the user selects one of these buttons and inputs a command by touching the corresponding electrostatic touchpad 14. If the user selects the refuse button 44 or the transfer button 45, the main controller 20 refuses to respond to or transfers the incoming call concerned.

As described above, when an incoming call has been received, the cell phone 1 disables input through the electrostatic touchpads 14 while the cell phone 1 is closed and the incoming call receiving state continues. The cell phone 1 enables input through the electrostatic touchpads 14 if the user responds to the incoming call, the incoming call is disconnected by the other party, the cell phone 1 makes a transition from the closed state to an open state in the incoming call receiving state, or the user makes a cancellation operation in the incoming call receiving state. With this measure, even if an electrostatic touchpad 14 is touched inadvertently when, for example, the user takes out the cell phone 1 upon occurrence of an incoming call in the cell phone 1, the cell phone 1 is prevented from performing an operation that is not intended by the user in response to the input.

The third embodiment makes it possible to prevent an erroneous input through an electrostatic touchpad 14 when an incoming call has occurred in an electronic apparatus (cell phone 1) in which plural casings are connected to each other in an openable/closable manner and electrostatic touchpads 14 are provided on the top outside surface.

The invention has been described above using the cell phones 1 as examples. However, the application field of the invention is not limited to cell phones and the invention can be applied to arbitrary electronic apparatus having at least two casings changeable in positional relationship between the at least two casings from a first state to a second state that is different from the first state, such as personal handyphone system (PHS) phones, personal digital assistants (PDAs), portable cameras, portable game machines, and portable TV receivers.

What is claimed is:

1. An electronic apparatus comprising:
at least two casings changeable in positional relationship between the at least two casings from a first state to a second state that is different from the first state;
an input module configured to input a command by touch;
a first detector configured to detect a start of a transition from the first state to the second state;
a second detector configured to detect a completion of the transition; and
an input controller configured to disable input through the input module in a time between the start detected by the first detector and the completion detected by the second detector.

2. The electronic apparatus of claim 1, wherein:
the first sate is a closed state and the second state is an open state;
the first detector is configured to detect a start of an action of opening the electronic apparatus; and
the second detector is configured to detect a completion of the action.

3. The electronic apparatus of claim 1, wherein:
the first sate is an open state and the second state is a closed state;
the first detector is configured to detect a start of an action of closing the electronic apparatus; and
the second detector is configured to detect a completion of the action.

4. An electronic apparatus comprising:
at least two casings changeable in positional relationship between the at least two casings from a first state to a second state that is different from the first state;
an input module configured to input a command by touch;
a detector configured to detect a start of a transition from the first state to the second state; and
an input controller configured to invalidate input through the input module when the detector detects the start of the transition in a time between a start and a completion of an input through the input module.

5. The electronic apparatus of claim 4, wherein:
the first state is a closed state and the second state is an open state;
the detector is configured to detect a start of an action of opening the electronic apparatus; and
the input controller is configured to invalidate input through the input module when the detector detects the start of the action in a time between a start and a completion of an input through the input module.

6. The electronic apparatus of claim 4, wherein:
the first state is an open state and the second state is a closed state;
the detector is configured to detect a start of an action of opening the electronic apparatus; and
the input controller is configured to invalidate input through the input module when the detector detects the start of the action in a time between a start and a completion of an input through the input module.

7. An electronic apparatus comprising:
at least two casings changeable in positional relationship from a first state to a second state, wherein the at least two casings are opened in the first state and the at least two casings are closed in the second state;
an input module configured to input a command by touch; and
an input controller configured to disable input through the input module when the electronic apparatus is in the second state and is receiving an incoming call.

8. The electronic apparatus of claim 7, further comprising a reception module configured to receive a cancellation command for canceling input disablement while the electronic apparatus is receiving the incoming call,
wherein the input controller is configured to enable input through the input module when the reception module receives the cancellation command.
